(19) United States
(12) Patent Application Publication
(10) Pub. No.: US 2026/0352537 A1
(43) Pub. Date: Nov. 5, 2026

(54) Method and device for transmitting an OFDM data frame

(71) Applicant: ORANGE, Issy-les-Moulineaux (FR)

(72) Inventors: Louis Adrien DUFRENE, CHATILLON (FR); Quentin LAMPIN, CHATILLON (FR)

(21) Appl. No.: 19/487,176

(22) PCT Filed: Jun. 19, 2024
(86) PCT No.: PCT/EP2024/067083

§ 371 Date: Nov. 24, 2025

(30) Foreign Application Priority Data
Jun. 22, 2023 (FR) FR2306541

(51) Int. Cl. H04L 27/26

(52) U.S. Cl. CPC H04L 27/2627; H04L 27/2605

(57) ABSTRACT

A method and a device for transmitting a data frame using OFDM including q binary words of size r modulated by particular cyclic shifting of a given root sequence of size N=2^{r} having at least one zero value. It is proposed to determine, for each i∈[0; N−1], a number of occurrences of a zero value at a position i of a sequence Cₚ of the q sequences making up the frame, to obtain a datum relating to the channel quality of N OFDM subcarriers, to apply a given cyclic shift to the q sequences coding for the q words of the frame to be transmitted, the value of the shift being such that it maximizes the number of non-zero values positioned on the subcarriers providing the best channels, and to transmit the q shifted sequences in q distinct OFDM symbols.

### TECHNICAL FIELD

The invention belongs to the field of telecommunications and in particular relates to a method for improving the link budget of an OFDM transmission.

### PRIOR ART

Low-power wide-area networks (LPWAN) are today still a major subject of research and innovation. A notable example of this is the deployment of satellite Internet of Things (IoT) networks, but also the evolution of cellular IoT markets with standards such as LTE-M, also called enhanced Machine Type Communication (eMTC), Narrowband IoT (NB-IoT) or long-range wide-area networks (LoRaWAN).

Such communications are generally subject to the same constraints: a need to communicate small quantities of data sporadically over long distances, or more generally with a very low link budget, with limited computing capacity. There is often the additional constraint of a finite energy source, since most of these objects run on batteries.

Orthogonal frequency-division multiplexing (OFDM) is a method of encoding digital signals by distributing them across orthogonal frequencies in the form of multiple subcarriers.

FIG. 1 schematically shows the architecture of an OFDM modulator.

A bitstream Rb/s is modulated by a modulator 100, for example a QAM, PSK, QPSK, CCSK modulator, etc. A serial-to-parallel converter 101 forms a block of N modulated symbols, which can be represented as a vector X(i). The vector X(i) is a sequence of complex values in the frequency domain which is then transformed into the time domain by an inverse discrete Fourier transform (IDFT) 102. A time-domain vector x(n) is then obtained, which is converted to serial format by a parallel-to-serial converter 103 after the addition of a cyclic prefix. The sequence thus formed passes through a digital-to-analog converter 104 to construct an analog baseband signal \tilde{x}(t), then a modulator 106 transposes the spectrum of the baseband signal about the carrier frequency fₚ. Thus, in OFDM, the data are divided into blocks of a size of N symbols. Each block is called an “OFDM symbol”.

FIG. 2 illustrates the architecture of an OFDM demodulator. The time-domain signal r(t) is transposed to baseband (200) and recovered by a low-pass filter (not shown). An analog-to-digital converter (201) transforms the signal into a sequence y(n). The sequence y(n) is fed into a serial-to-parallel converter (202), which removes the cyclic prefix and creates vectors of time-domain samples y(i), i∈[0; N−1]. The direct application of the discrete Fourier transform (203) transforms the symbols y(i), i∈[0; N−1] to obtain a sequence of complex values Y(i) in the frequency domain. A serial-to-parallel converter (204) feeds a demodulator (205) thereby enabling the transmitted data to be recovered.

In OFDM, frequency and/or time synchronization is generally achieved using pilot symbols, which are sequences of predefined values, known to the receiver. By calculating a correlation between a received sequence and the predefined sequence, the receiver is able to determine a time or frequency shift and adjust the synchronization. Pilot symbols do not carry payload data, but they contribute to energy consumption and limit bandwidth.

Cyclic code-shift keying (CCSK) modulation can make it possible to limit the energy consumption associated with the transmission of pilot signals. This modulation method proposes to modulate the data to be transmitted by cyclically rotating a root sequence of complex symbols called chips. The root sequence is such that its shifted versions are orthogonal to each other, i.e. it has a good autocorrelation function. Thus, a particular cyclic shift of the root sequence is associated with each binary word to be transmitted. Since the root sequence is known to the receiver, the transmitted sequences can be used as pilots for synchronization and channel estimation.

For example, a root sequence made up of 4 complex symbols [a; b; c; d] can be used to modulate 2-bit binary words. The word ‘00’ is for example associated with a zero shift corresponding to the sequence [a; b; c; d], the word ‘01’ with a shift of one position corresponding to the sequence [d; a; b; c], the word ‘10’ with a shift of two positions corresponding to the sequence [c; d; a; b] and the word ‘11’ with a shift of 3 positions corresponding to the sequence [b; c; d; a].

At the receiver, demodulation is performed by cross-correlation with the root sequence. The location of greatest correlation indicates the modulated information through inverse mapping. For example, to demodulate the sequence [d; a; b; c], the result of the cross-correlation with the root sequence [a; b; c; d] gives the normalized result [0; 1; 0; 0]. The greatest correlation with this index corresponds to the binary word ‘01’.

CCSK modulation can advantageously be combined with OFDM transmission so that each element making up a CCSK sequence, called a chip, is transmitted on a distinct OFDM subcarrier.

It is possible for disturbances to affect different OFDM subcarriers in different ways. Thus, it is common practice in OFDM to prioritize transmission on subcarriers that have a better propagation channel. By selecting the “good” subcarriers in the frequency domain, the transmitter can improve its link budget and thus the performance of the system. To do this, a channel estimate is required for each subcarrier. For example, to perform a channel estimate on the subcarriers, a user equipment either uses the downlink directly (for example time-division duplex or TDD system), or a base station transmits channel state information (CSI) thereto.

Unfortunately, when CCSK modulation and OFDM transmission are used in combination, the demodulation step requires calculating a correlation on a set of subcarriers on which the transmitted sequence chips are distributed. Since the size of the sequences can quickly reach large values (64, 128, 256 . . . ), the possibilities are limited when trying to optimize the link budget by prioritizing subcarriers providing a good channel and avoiding modulating data on subcarriers of poor quality. Furthermore, if too many channels are of poor quality, the position of the greatest correlation will be incorrect, resulting in the complete loss of information and thus representing a significant waste of resources and energy.

There is therefore a need for a technique for prioritizing subcarriers providing a good transmission channel in CCSK OFDM communication.

### SUMMARY OF THE INVENTION

A method for transmitting a data frame comprising q binary words of size r, each binary word p of the frame being modulated by a sequence Cₚ of size N=2^{r} complex values obtained by particular cyclic shifting of a given root sequence of size N comprising at least one zero value, each sequence Cₚ being transmitted in a distinct OFDM symbol in which each complex value Cₚ[n], n∈[0; N−1], is positioned on a particular subcarrier, the method comprising the following steps:
Determining, for each position i∈[0; N−1], the number of occurrences of a zero value at a position i of a sequence Cₚ of the q sequences making up the frame,
Obtaining a datum relating to the channel quality of N OFDM subcarriers,
Applying a given cyclic shift to the q sequences coding for the q words of the frame to be transmitted, the value of the shift being such that it maximizes the number of non-zero values positioned on the subcarriers providing the best channels,
Transmitting the q shifted sequences in q distinct OFDM symbols.

In this way, the method improves the link budget by concentrating the transmission of non-zero values on carriers of better quality (or conversely, by concentrating the transmission of zero values on subcarriers of low quality). Since zero values are not affected by a noisy transmission channel, such an arrangement limits transmission errors and improves transmission efficiency.

The sequences are shifted by the same value so that the relative shift between them remains the same, which allows the receiver to decode the received frame using a shifted demodulation technique.

A root sequence with a perfect autocorrelation function (a single correlation peak for a zero shift) makes it possible to obtain the best demodulation performance.

According to a particular embodiment, the step of applying a given cyclic shift comprises determining a shift value equal to the difference between the index of the subcarrier having the noisiest transmission channel and the position at which the number of occurrences of a zero value in the sequences making up the frame is greatest.

It is thus proposed to determine a particular cyclic shift value to be applied to all the CCSK sequences making up a frame to be transmitted in order to maximize the number of zero values to be transmitted on the subcarrier of lower quality.

According to a particular embodiment, the step of applying a given cyclic shift comprises determining a shift value equal to the difference between the index of the subcarrier having the least noisy transmission channel and the position at which the number of occurrences of a non-zero value in the sequences making up the frame is greatest.

This prioritizes the transmission of non-zero values on the subcarrier of better quality.

The invention also relates to a device for transmitting a data frame comprising q binary words of size r, each binary word p of the frame being modulated by a sequence Cₚ of size N=2^{r} complex values obtained by particular cyclic shifting of a given root sequence of size N comprising at least one zero value, each sequence Cₚ being transmitted in a distinct OFDM symbol in which each complex value Cₚ[n], n∈[0; N−1], is positioned on a particular subcarrier, the device comprising an OFDM modulator, and a processor coupled to a memory in which are recorded instructions designed to perform the following steps:
Determining, for each position i∈[0; N−1], the number of occurrences of a zero value at a position i of a sequence Cₚ of the q sequences making up the frame,
Obtaining a datum relating to the channel quality of N OFDM subcarriers,
Applying a given cyclic shift to the q sequences coding for the q words of the frame to be transmitted, the value of the shift being such that it maximizes the number of non-zero values positioned on the subcarriers providing the best channels,
Transmitting the q shifted sequences in q distinct OFDM symbols.

According to another aspect, the invention relates to a communication terminal comprising a device as described above.

According to yet another aspect, the invention relates to a communication system comprising such a communication terminal.

In one particular embodiment, the various steps of the transmission method are determined by computer program instructions.

As a result, the invention also relates to a computer program including instructions designed to implement the steps of a transmission method as described above when the program is executed by a processor.

This program can use any programming language, and be in the form of source code, object code, or intermediate code between source code and object code, such as in a partially compiled form, or in any other desirable form.

The invention also relates to a computer-readable information medium on which there is recorded a computer program comprising instructions for executing the steps of a transmission method as described above.

The information medium may be any entity or device capable of storing the program. For example, the medium may include a storage means, such as a ROM, for example a CD-ROM or a microelectronic circuit ROM, a flash memory, or else a magnetic recording means, such as a hard disk.

On the other hand, the information medium may be a transmissible medium such as an electrical or optical signal that may be routed via an electrical or optical cable, by radio or by other means. The program according to the invention may, in particular, be downloaded over the Internet.

Alternatively, the information medium may be an integrated circuit in which the program is incorporated, the circuit being designed to execute or to be used in the execution of the method in question.

The various abovementioned embodiments or implementation features may be added, independently or in combination with one another, to the steps of the transmission method.

The devices, terminals, communication systems, programs and information media have advantages similar to those conferred by the method to which they correspond.

### BRIEF DESCRIPTION OF THE FIGURES

Other features and advantages will become apparent on reading a preferred embodiment described with reference to the attached drawings, in which:

FIG. 1 shows the operating principle of an OFDM modulator,

FIG. 2 illustrates the operating principle of an OFDM demodulator,

FIG. 3 shows an environment suitable for implementing the transmission and reception methods according to one particular embodiment,

FIG. 4 is a flowchart showing the main steps of a transmission method according to one particular embodiment,

FIG. 5 shows 4 sequences comprising a zero value modulating 4 binary words, the chips of which are placed opposite 4 OFDM subcarriers,

FIG. 6 shows the effect of applying a shift equal to one inter-carrier spacing to the sequences in FIG. 5,

FIG. 7 schematically shows an architecture of a device designed to implement the transmission method according to one particular embodiment.

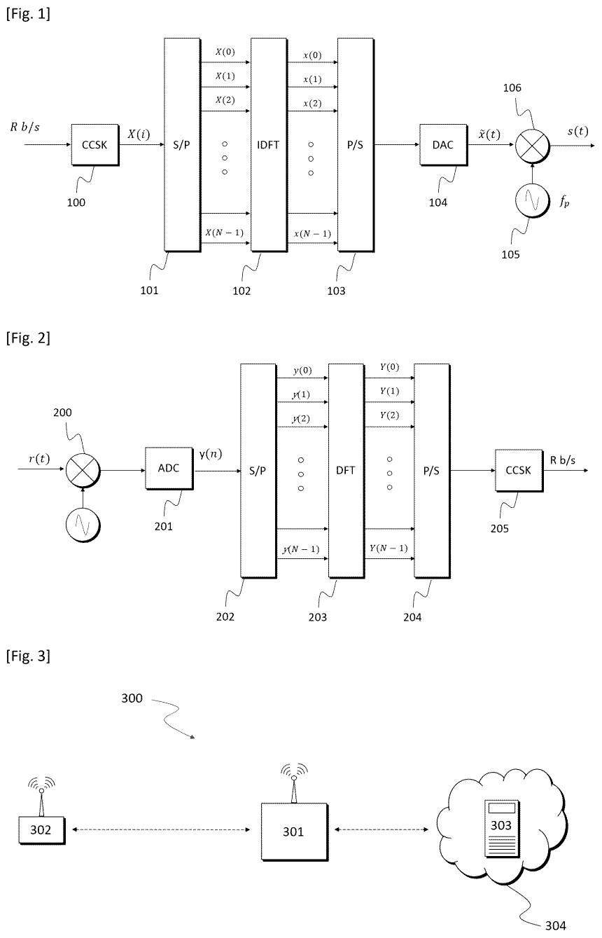

### DETAILED DESCRIPTION

In the following description, embodiments are described on the basis of non-limiting examples to explain the concepts on which the invention is based. In particular, although the examples and terminology used may refer to certain well-known technologies or standards, these references are not limiting and other technologies may be suitable for implementing the concepts of the invention. For example, the CCSK or OFDM modulation technologies referred to may be replaced by different modulation techniques based respectively on circular shifts of sequences of complex values or on multi-carrier transmissions, without having to modify the invention.

FIG. 3 shows an environment 300 suitable for implementing the transmission method according to one particular embodiment.

The environment 300 comprises a wireless equipment 301, for example a gateway or a relay, designed to communicate on the one hand with a device 302 and on the other hand with a server 303 of a communication network 304. Of course, this example is given by way of illustration and other types of equipment or other configurations of the environment may be used to implement the invention. For example, the invention can be implemented between two equipments in communication. The device 302 is, for example, a sensor, a machine-to-machine (M2M) communication device, or a communication terminal such as a tablet or a cellphone, for example. The gateway 301 may be a home gateway, such as a Wi-Fi router, or a base station of a cellular communication network, an eNodeB, or a gNodeB.

In the example in FIG. 3, the gateway 301 communicates with the device 302 to exchange data using multi-carrier modulation, for example OFDM modulation.

To transmit a data frame to the gateway 301 under the best conditions, the device 302 implements the transmission method according to a particular embodiment. In this way, subcarriers with a high-quality channel are prioritized for transmission, and connection efficiency is improved.

A data “frame” or “packet” here means a transmission unit comprising one or more binary words that may be associated with an integrity check mechanism, for example a cyclic redundancy check (CRC). Such an integrity check mechanism is known per se and is used to detect transmission errors. For example, a data frame prepared by the device 302 may comprise one or more binary words constituting payload data, and one or more binary words, or even part of a binary word, comprising data for checking the integrity of the frame.

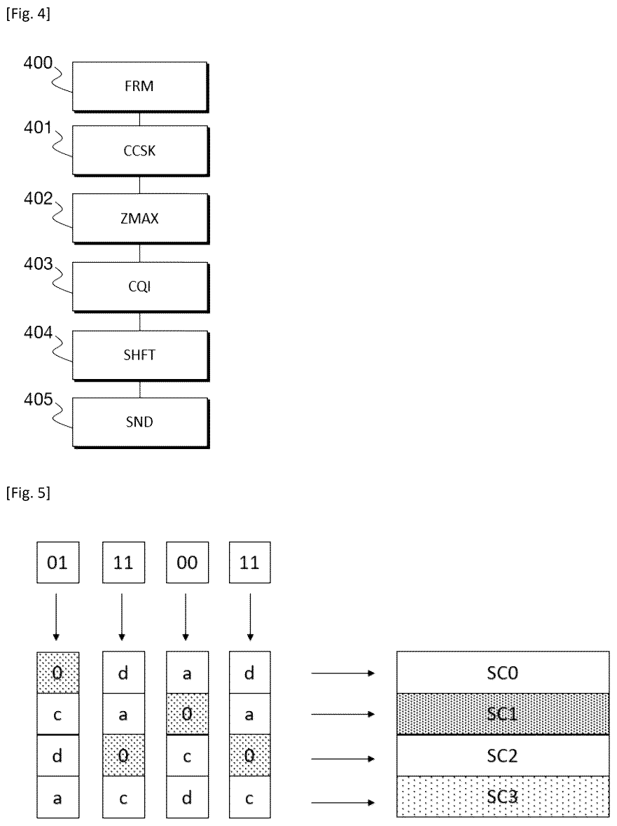

FIG. 4 is a flowchart illustrating the main steps of a particular embodiment of the transmission method according to the present description.

During a first step 400, the device 302 prepares a first data frame to be transmitted to the gateway 301. The frame comprises q binary words of size r bits to be transmitted.

Preferably, the frame comprises data used for an integrity check, enabling the receiver to verify the integrity of the received bits, for example a checksum or a CRC.

In step 401, the binary words making up the prepared frame are modulated. For this purpose, each binary word is associated with a particular sequence of complex values obtained by cyclically shifting a root sequence of size N=2^{r}, the root sequence comprising at least one zero value. For example, the device 302 can use CCSK modulation.

A root sequence comprising at least one zero value can be obtained in different ways. For example, an oversampled Zadoff-Chu sequence can be used, i.e. a sequence in which zero values are inserted between the elements of the sequence.

FIG. 5 shows an example of modulating a data frame comprising 4 2-bit binary words, “01”, “11”, “00” and “11”.

Each binary word is modulated by a particular shift of a root sequence [a, 0, c, d] having a zero value at index 1. Thus, the binary word “00” is associated with a zero shift of the root sequence, i.e. with the root sequence itself. The word “01” is associated with a shift of one position, i.e. [0, c, d, a], the binary word “10” is associated with the sequence [c, d, a, 0] and the binary word “11” is associated with the sequence [d, a, 0, c], i.e. a cyclic shift of 3 positions.

The frame is thus modulated by the sequences C₀=[0, c, d, a], C₁=[d, a, 0, c], C₂=[a, 0, c, d], and C₃=[d, a, 0, c].

The root sequence [a, 0, c, d] used is such that it has a good autocorrelation function, or a perfect autocorrelation function.

By the end of step 401, q vectors of complex values corresponding to the q sequences Cₚ of size N=2^{r} used to modulate the binary words of the frame have been obtained. Each sequence thus obtained is intended to be transmitted in an OFDM symbol in which each element of a sequence is associated with a particular OFDM subcarrier. FIG. 5 thus shows 4 subcarriers denoted SC0 to SC3 corresponding to the 4 complex values of the sequences to be transmitted.

In a step 402, for each index i, i∈[0; N−1], the number of occurrences of a zero value at the index i in the set of q sequences that make up the frame is counted to determine the positions at which zero values are most frequent in the frame. In the example in FIG. 5, one zero value is thus counted at indices 0 and 1, two zero values at index 2 and no zero values at index 3.

In step 403, the device obtains a channel estimate for each subcarrier. For example, the device can determine such estimates directly if it is using a time-division duplex (TDD) transmission system, the uplink and downlink data using the same frequencies, or use channel state indicators (CSI) transmitted by the remote device. Channel estimation allows the device to obtain an indicator relating to the actual transmission quality on the different subcarriers.

FIG. 5 shows the transmission quality for each of the subcarriers SC0 to SC3 using greyscale. Thus, the subcarriers SC0 and SC2 are of good quality, whereas the subcarrier SC3 is of degraded quality and the subcarrier SC1 is of very degraded quality. As shown in FIG. 5, the values positioned at index 3 in the sequences to be transmitted are positioned on the OFDM subcarrier SC3, which is of degraded quality. It also shows that the complex values situated at index 2 comprise two zero values and are positioned on the subcarrier SC2, which provides a channel of good quality.

The method comprises a step 404 during which the quality of the subcarriers is matched with the numbers of zero values counted in the sequences making up the frame to determine a cyclic shift to be applied to the sequences to optimize the positioning of the complex values on the subcarriers.

In practice, a particular cyclic shift to be applied to the sequences which make up the frame is determined, which makes it possible to maximize the number of non-zero values transmitted on subcarriers of good quality and/or which maximizes the number of zero values transmitted on subcarriers of low quality. For this purpose, in a particular embodiment, an index i∈[0; N−1] is determined such that the number of occurrences of a zero value at a position i of a sequence Cₚ of the q sequences making up the frame is greatest, an index j corresponding to the position of the subcarrier providing the channel of lowest quality is determined, and a cyclic shift of value d=i−j is applied to the q sequences coding for the q words of the frame to be transmitted. The applied shift cyclically rotates the elements of the sequences in order to move the positions where the zero values are most frequent opposite the subcarrier of lowest quality.

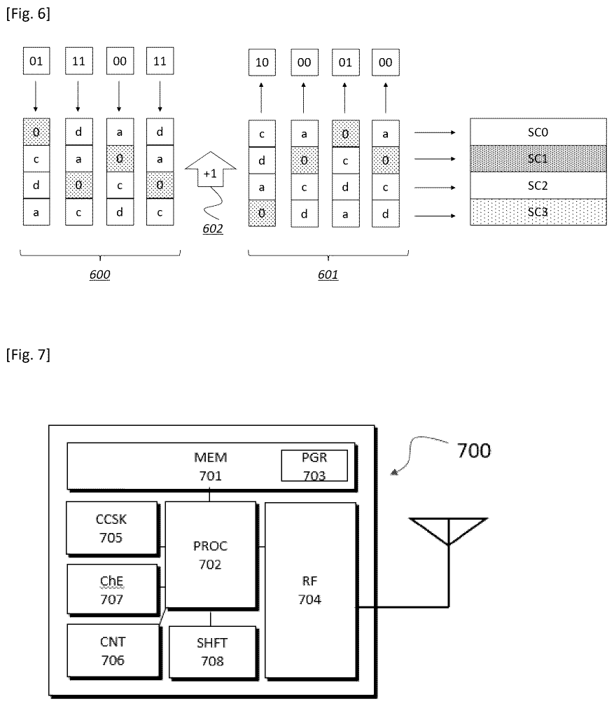

FIG. 6 shows the 4 sequences in FIG. 5 before (600) and after (601) applying a cyclic shift of one position (602). As shown, the zero values are now more numerous at index 1 and positioned on the subcarrier SC1, which is of the lowest quality. Moreover, no zero elements are positioned on the subcarrier SC2, which is of satisfactory quality. To determine the value of the shift applied, the absolute value of the difference between the position having the most zero values and the position of the subcarrier of lowest quality is determined. In other words, the applied shift d corresponds in this example to the difference between the position i at which the zero values are the most frequent and the index j of the subcarrier of lowest quality, i.e. d=i−j.

Alternatively or in combination, a shift can similarly be determined using the difference between the position with the most non-zero values and the position of the subcarrier of highest quality, so as to prioritize the transmission of the non-zero values on subcarriers of good quality.

Of course, the root sequence used for CCSK modulation may comprise a plurality of zero values. In general, the shift is determined to optimize globally the positioning of the zero values on the subcarriers of lower quality, thereby optimizing the final link budget.

According to a particular embodiment, the expected link budget is evaluated for each sequence and for each possible shift and a score is calculated from a weighted mean of these link budgets. The different calculated scores can thus be used to determine the best shift to apply.

The shift applied in FIG. 6 results in a modification of the binary frame after demodulation at the receiver. In fact, since the binary words are modulated by a particular shift, a modification of this shift modifies the binary word during demodulation. Thus, the demodulation of the shifted sequences such as in FIG. 6 gives the binary words “10”, “00”, “01” and “00”.

To recover the initial frame, the receiver can implement shifted demodulation.

For this purpose, the receiver reconstructs the transmitted frame by demodulating the sequences received successively in the OFDM symbols using the root sequence used for the modulation. This root sequence is known to the receiver, for example because it is defined by a standard, or because it was negotiated during an initial configuration step. The receiver can then verify the integrity of the reconstructed frame from a checksum or a CRC associated with the frame. If the integrity check shows that the frame is erroneous, the receiver can apply a cyclic shift to all the sequences in the frame and carry out another demodulation before rechecking the integrity thereof. The operation is thus repeated by the receiver until a positive integrity check allows it to determine the shift applied to the transmission.

The method finally comprises a step 405 during which the OFDM symbols carrying the shifted sequences are transmitted to the gateway 301 in a conventional manner.

FIG. 7 illustrates the architecture of a device 700 designed to implement the transmission method for a data frame according to one particular embodiment of the invention.

The device 700 comprises a data processing module comprising a storage space 701, for example a memory (MEM), a processing unit 702, equipped for example with a microprocessor (PROC), and driven by a computer program (PGR) 703, the instructions of which are configured to implement the transmission method as described above with reference to FIG. 4.

On initialization, the code instructions of the computer program 703 are for example loaded into the memory 701, before being executed by the processor of the processing unit 702.

The microprocessor of the processing unit 702 implements, according to the instructions of the computer program 703, the steps of the transmission method that are described above with reference to FIG. 4.

For this purpose, in addition to the memory 701 and the processor 702, the device comprises communication means 704, for example a 3G, 4G, 5G, Wi-Fi network interface or the like, comprising an OFDM transducer designed to transmit and receive signals over a plurality of orthogonal carriers. The communication means 704 are for example configured by computer program instructions to enable the transmission of a sequence of complex values by distributing these complex values over distinct subcarriers of an OFDM symbol.

The device 700 further comprises a CCSK modulator 705. The modulator 705 is for example configured by appropriate code instructions to associate each binary word p of size r bits of a frame of q binary words with a particular sequence Cₚ comprising N=2^{r} complex values, obtained by cyclically shifting a root sequence comprising at least one zero value and having a good autocorrelation function, or even a perfect autocorrelation function.

The device 700 also comprises an analysis module 706. The analysis module 706 is for example implemented by code instructions configured to determine, from the q sequences making up the frame, a frequency of occurrence of a zero value at a location i∈[0; N−1] of a sequence Cₚ. For this purpose, the module can place the q sequences of N elements making up the frame in the columns of a matrix, and count the number of zero values row by row.

The device 700 also comprises a channel estimation module 707. The estimation module 707 is configured by appropriate code instructions to obtain an estimate of the downlink channel of a plurality of OFDM subcarriers. The module can obtain such a datum from CSI messages transmitted by another device, or else by estimating the uplink channel if the transmission uses TDD technologies for example. In practice, the estimation module is configured to associate a quality level with each OFDM subcarrier.

The device finally comprises a cyclic shift module 708. The shift module can be implemented by code instructions configured to determine a cyclic shift to be applied to the q sequences of the frame so as to maximize the number of zero values positioned on subcarriers of low quality and/or so as to maximize the number of non-zero values positioned on subcarriers of good quality. In a particular embodiment, the shift d is determined by the absolute value of the difference between the index of the position comprising the most zero values and the index of the subcarrier of lowest quality. To apply the shift of one position, the module 708 can for example cause aliasing (or spectrum overlap) by means of a frequency shift equal to one inter-carrier spacing.

The communication module 704 is further configured to generate and transmit q OFDM symbols from the q shifted sequences.

According to a particular embodiment, the device 700 is included in a communication terminal, a connected object or sensor, a base station or any type of communicating equipment implementing multicarrier transmission.

1. A method implemented by a transmitting device and comprising:
transmitting a data frame comprising q binary words of size r, each binary word p of the frame being modulated by a sequence Cₚ of size N=2^{r} complex values obtained by particular cyclic shifting of a given root sequence of size N comprising at least one zero value, each sequence Cₚ being transmitted in a distinct Orthogonal Frequency-Division Multiplexing (OFDM) symbol in which each complex value Cₚ[n], n∈[0; N−1], is positioned on a particular subcarrier, the transmitting:
determining, for each i∈[0; N−1], a number of occurrences of a zero value at a position i of a sequence Cₚ of the q sequences making up the frame;
obtaining a datum relating to the channel quality of N OFDM subcarriers;
applying a given cyclic shift to the q sequences coding for the q words of the frame to be transmitted, the value of the shift being such that the value maximizes the number of non-zero values positioned on the subcarriers providing the best channels; and
transmitting the q shifted sequences in q distinct OFDM symbols.

2. The method as claimed in claim 1, wherein the applying a given cyclic shift comprises determining a shift value equal to a difference between an index of the subcarrier having a noisiest transmission channel and the position at which the number of occurrences of a zero value in the sequences making up the frame is greatest.

3. The method as claimed in claim 1, wherein the applying a given cyclic shift comprises determining a shift value equal to the difference between an index of the subcarrier having a least noisy transmission channel and the position at which the number of occurrences of a non-zero value in the sequences making up the frame is greatest.

4. A transmission device comprising:
an Orthogonal Frequency-Division Multiplexing (OFDM) modulator;
at least one processor; and
at least one memory on which are recorded instructions which when executed by the at least one processor configure the transmission device to transmit a data frame comprising q binary words of size r, each binary word p of the frame being modulated by a sequence Cₚ of size N=2^{r} complex values obtained by particular cyclic shifting of a given root sequence of size N comprising at least one zero value, each sequence Cₚ being transmitted in a distinct OFDM symbol in which each complex value Cₚ[n], n∈[0; N−1], is positioned on a particular subcarrier, the transmitting comprising:
determining, for each i∈[0; N−1], a number of occurrences of a zero value at a position i of a sequence Cₚ of the q sequences making up the frame;
obtaining a datum relating to the channel quality of N OFDM subcarriers;
applying a given cyclic shift to the q sequences coding for the q words of the frame to be transmitted, the value of the shift being such that the value maximizes the number of non-zero values positioned on the subcarriers providing the best channels; and
transmitting the q shifted sequences in q distinct OFDM symbols.

5. A communication terminal comprising the transmission device as claimed in claim 4.

6. (canceled)

7. A non-transitory computer-readable information medium on which there is recorded a computer program comprising instructions for executing the transmission method as claimed in claim 1, when the instructions are executed by at least one processor of the transmission device.
